(19) United States
(12) Patent Application Publication
(10) Pub. No.: US 2019/0111723 A1
(43) Pub. Date: Apr. 18, 2019

(54) OPTICALLY VARIABLE DEVICE AND METHOD OF FORMING THEREOF

(71) Applicant: DE LA RUE INTERNATIONAL LIMITED, Basingstoke, Hampshire (GB)

(72) Inventor: Robert WHITEMAN, Berkshire (GB)

(73) Assignee: DE LA RUE INTERNATIONAL LIMITED, Basingstoke, Hampshire (GB)

(21) Appl. No.: 16/090,348

(22) PCT Filed: Mar. 23, 2017
(86) PCT No.: PCT/GB2017/050822

§ 371 Date: Oct. 1, 2018

(30) Foreign Application Priority Data
Mar. 31, 2016 (GB) 1605404.1

(51) Int. Cl. B42D 25/351; B42D 25/364; B42D 25/378; B42D 25/45; G02B 5/28; G02B 5/00; G02B 1/00

(52) U.S. Cl. CPC B42D 25/351; B42D 25/364; B42D 25/378; B42D 25/21; G02B 5/285; G02B 5/003; G02B 1/005; B42D 25/45

(57) ABSTRACT

An optically variable device comprising a substrate having a transparent viewing region and a layer of optical interference structure material for selectively reflecting and transmitting incident light to generate an optically variable effect. The layer of optical interference structure material has a front side and a rear side, the device further comprising an absorbing layer comprising an at least partially light absorbing material on the rear side of the layer of optical interference structure material. When a region on the front side of the layer of optical interference structure material receives incident light and the device is viewed in reflected light, the absorbing layer is sufficiently opaque to absorb light that passes through the optical interference structure material and the optically variable effect is observable in reflected light.

### FIELD OF THE INVENTION

The invention relates to optically variable devices, for example for inclusion in or on a security document, such as a document of value. The invention also relates to methods of forming optically variable devices.

### BACKGROUND TO THE INVENTION

Articles of value, and particularly documents of value such as bank notes, cheques, passports, identification documents, certificates and licences, are frequently the target of counterfeiters and persons wishing to make fraudulent copies thereof and/or changes to any data contained therein. Typically such objects are provided with a number of visible devices which are difficult to counterfeit and therefore are useful for checking the authenticity of the article.

One class of devices are those which produce an optically variable effect, meaning that the appearance of the device is different at different angles of view. Such devices are particularly effective since direct copies (e.g. photocopies) will not produce the optically variable effect and hence can be readily distinguished from genuine devices. Optically variable effects can be generated based on various different mechanisms, including holograms and other diffractive devices, moiré interference and other mechanisms relying on parallax such as venetian blind devices. Certain devices which make use of optically variable effects require the use of at least one transparent material representing a viewing region or “window”.

Optically variable devices that exhibit angularly dependent coloured effects are also known, including so-called “optical interference structure materials”, which display different colours at different viewing angles. Such materials may include so-called “iridescent amplitude interference materials”. Examples include thin-film interference structures, interference pigments, pearlescent pigments, liquid crystal film and pigments, photonic crystals and the like. Thin film interference structures comprise repeating layers of different refractive indices, and can include, for example, purely dielectric stacks (metal oxide or polymer) or can be composed of alternate dielectric and metallic layers. Thin film interference structures are also known as Bragg stacks or 1D photonic crystals.

What all of the above examples have in common is the provision of two or more closely spaced interfaces, at least one of which partially reflects and partially transmits incident light, i.e. the amplitude of the incident light is split. The transmitted portion is reflected at the second or subsequent interfaces and interferes with the portion reflected from the first or earlier interfaces, leading to constructive interference of some wavelengths and destructive interference of others, and hence a characteristic colour which varies with viewing angle.

Although optically variable devices displaying angularly dependent coloured effects are known, there is no teaching in the prior art on how to incorporate such devices into security documents to achieve observable effects in reflection as well as in transmission from the same region of material receiving incident light. The object of the current invention is to improve the security of the devices described in the prior art.

### SUMMARY OF THE INVENTION

In accordance with one aspect of the present invention, there is provided an optically variable device comprising a substrate having a transparent viewing region and a layer of optical interference structure material for selectively reflecting and transmitting incident light to generate an optically variable effect, the layer of optical interference structure material having a front side and a rear side, the device further comprising an absorbing layer comprising an at least partially light absorbing material on the rear side of the layer of optical interference structure material, such that,
when a region on the front side of the layer of optical interference structure material receives incident light and the device is viewed in reflected light, the absorbing layer is sufficiently opaque to absorb light that passes through the optical interference structure material and the optically variable effect is observable in reflected light; and
when the same region on the front side is viewed in transmitted light, the absorbing layer is sufficiently transparent to permit the passage of light with an intensity that exceeds the intensity of reflected light for the optically variable effect to be observable in transmitted light.

The present inventors have realised that by using a layer of optical interference structure material applied to a window (transparent viewing region of the substrate) in combination with at least partially absorbing material which is capable of absorbing as well as transmitting light, it is possible to observe strong reflection as well as transmission effects from the same region of optical interference structure material illuminated with incident light. The absorbing layer comprising the at least partially light absorbing material is preferably in the form of a screen which backs the layer of optical interference structure material.

On one hand, when viewed in reflection from the front side, the absorbing layer is sufficiently opaque to absorb wavelengths of light which are not reflected by the optical interference structure material and reaches the absorbing layer. A sufficiently high proportion of the light transmitted through the layer of optical interference structure material will be absorbed so that the colour reflected off the optical interference structure material dominates. On the other hand, the obscuring layer appears semi-transparent when viewed in a sufficiently bright light in a direction normal to the absorbing layer. On transmissive viewing with white incident light therefore, the intensity of the transmission colours exceed the intensity of the reflective colours and show through in a genuine document. This optical variable effect is striking and therefore memorable to the user.

As mentioned previously, the expression “optical interference structure material” is used to refer to any material which can selectively reflect or transmit incident light to create an optically variable effect, for example an angularly dependent coloured reflection or transmission (typically referred to as a “colour shift” effect). In examples described herewith, when visible light is being used, an optical interference structure material may also be referred to as a “colour shift” material. Examples include photonic crystals, liquid crystals, interference pigments, pearlescent pigments, structured interference materials or thin film interference structures including Bragg stacks, as will be described in more detail with reference to the examples given below.

The incident light may comprise visible and/or non-visible light. Likewise, the optical interference structure material may be arranged to selectively reflect light in the non-visible part of the spectrum (including ultra-violet and infra-red). When the incident light is produced by a white light (broad wavelength band) source, preferably the optical variable effect is a colour effect. The optically variable effect is therefore preferably an angularly dependent colour effect.

Advantageously, the light absorbing material absorbs at least 70% of incident visible light, preferably at least 80%, more preferably at least 90%. Visible light is defined here as meaning all light with wavelengths between 350 nm and 800 nm, inclusive. Advantageously the light absorbing material is additionally non-transparent and preferably transmits less than 30% of incident visible light in a single pass, more preferably less than 20%, still preferably less than 10%, most preferably is substantially opaque.

Preferably, the absorbing layer has black or dark areas, however this is not essential, so long as the absorbing layer absorbs reflected light from the optical interference structure material. Desirably, the light absorbing material is dark in colour, preferably black, although alternatives such as dark blue or dark green are also envisaged. For example, the light absorbing material may comprise an ink containing a dark pigment such as carbon black. The light absorbing material may also comprise a magnetic or electrically conductive substance, which may or may not be the same pigment as that which gives the material its colour.

Preferably, the absorbing layer is in the form of a screen. For example, the pattern of absorbing material could be an array of dots or lines with sufficient coverage to maintain reflectivity of the iridescent amplitude interference, but sufficiently transparent to enable transmission colours to shine through the screen. The screen can be regular or stochastic. Indeed, the term “screen” should be construed broadly to encompass many different shapes of screen elements.

Preferably, the coverage of the screen pattern is in the range 20-80%, and more preferably in the range 40-70% and even more preferably in the range 50-60%. The width of the lines or the diameter of the dots forming the screen are preferably in the range 50-300 μm and the spaces between the dots or lines are also in the range 50-300 μm with values of each set chosen to achieve the desired screen coverage and more preferably in the range 50-200 μm. Typically therefore the dimensions of the fine detail of the screen, that is the lines, dots or other shapes and the spaces therebetween, are of a scale which is not easily resolvable by the human naked eye.

The region that is viewed in reflected light, that being the same region that is viewed in transmitted light, is of a sufficient size to be resolvable by the naked eye and therefore typically has lateral dimensions being each of at least 1 millimetre and more preferably at least 3 mm and even more preferably. The larger dimensions of this region in comparison with the finer detail structures discussed above, means that the optical effects of the finer detail are averaged and have a combined effect that is homogeneous in appearance to the naked eye across the viewed region.

Advantageously, appropriate patterning of the absorbing layer may further provide a means of integrating hidden transmission designs. Preferably, parts of an absorbing layer are filled to define an image such as indicia.

The shapes of each of the absorbing layer and the optical interference structure material may be the same, such that for example they have similar footprints that are coincident. Furthermore, whether coincident with the shape of the optical interference structure material or otherwise, the absorbing layer may be shaped, for example so as to form one or more indicia. This allows for further advantageous optical effects to be presented to the user.

Advantageously, devices according to the invention are particularly well suited to deployment on security documents based on polymer document substrates, such as polymer banknotes, since the polymer document substrate can be selected to be transparent and so provide a transparent viewing region or “window” in the document. It will be appreciated however that devices can be formed using a transparent material which is applied to a security document of any sort, such as a conventional paper-based document.

The substrate in the viewing region may be the same substrate as that of the secure document it is protecting, for example the security feature of the current invention may be applied by printing the patterns on either side of a traditional banknote paper. The substrate may be more transparent in the viewing region than elsewhere. In the case of a solely paper substrate the area of greater transparency will be formed typically during the manufacture of the substrate as described in GB-A-2282611 and GB-A-2283026.

Alternatively the substrate comprises a substantially transparent viewing region comprising a polymeric material. Techniques are known in the art for forming transparent regions in both paper and polymeric substrates. For example, WO-A-8300659 describes a polymer banknote formed from a transparent substrate comprising an opacifying coating on both sides of the substrate. The opacifying coating is omitted in localised regions on both sides of the substrate to form a transparent region. WO-A-0039391 describes a method of making a transparent polymeric region in a paper substrate. Other methods for forming transparent regions in paper substrates are described in EP-A-723501, EP-A-724519 and WO-A-03054297.

Examples of security documents with which the present invention can be used include banknotes, fiscal stamps, cheques, postal stamps, certificates of authenticity, articles used for brand protection, bonds, payment vouchers, and the like.

In accordance with another aspect of the present invention, there is also provided a method of forming a security device, comprising the steps of:

providing a substrate having a transparent viewing region;
providing, in the transparent viewing region, a layer of optical interference structure material for selectively reflecting and transmitting incident light to generate an optically variable effect, the layer of optical interference structure material having a front side and a rear side, and
providing an absorbing layer comprising an at least partially light absorbing material on the rear side of the layer of optical interference structure material, such that:
when a region on the front side of the layer of optical interference structure material receives incident light and the device is viewed in reflected light, the absorbing layer is sufficiently opaque to absorb light that passes through the optical interference structure material and the optically variable effect is observable in reflected light; and
when the same region on the front side is viewed in transmitted light, the absorbing layer is sufficiently transparent to permit the passage of light with an intensity that exceeds the intensity of reflected light for the optically variable effect to be observable in transmitted light.

In summary, aspects of the present invention achieve observable optically variable effects, such as angular dependent colours, in reflection as well as transmission from a single region of optical interference structure material receiving incident light. The effects are strong enough to be observed with the naked eye when the incident light is white light. This is made possible by applying an at least partially light absorbing layer, to a layer of photonic material in a window of the security document. When the device is viewed in reflection, the opaque (e.g. black or dark) areas of the absorbing layer will dominate and optically variable effects are seen in reflected light. When viewed in transmission, for example by holding up the device against a sufficiently bright incident light, the intensity of the transmitted light exceeds the intensity of the reflected light and shows through the obscuring layer. The device has the advantage of conveniently authenticating a document by simply changing the angle of view, with striking optically variable effects in both reflected and transmitted light.

### BRIEF DESCRIPTION OF THE DRAWINGS

Some examples of security devices located on or in security documents according to the invention will now be described with reference to the accompanying drawings, in which:—

FIGS. 1a-1c shows are sections through examples an optically variable device according to the invention;

FIG. 2 shows an example of a dot screen for use as an at least partially light absorbing layer according to the invention;

FIG. 3a-3c are example plan views of a windowed security document carrying an example device according to the invention, when viewed in reflection from either side of the document and in transmission respectively;

FIG. 4 shows a further example of an optically variable device.

### DESCRIPTION OF EMBODIMENTS

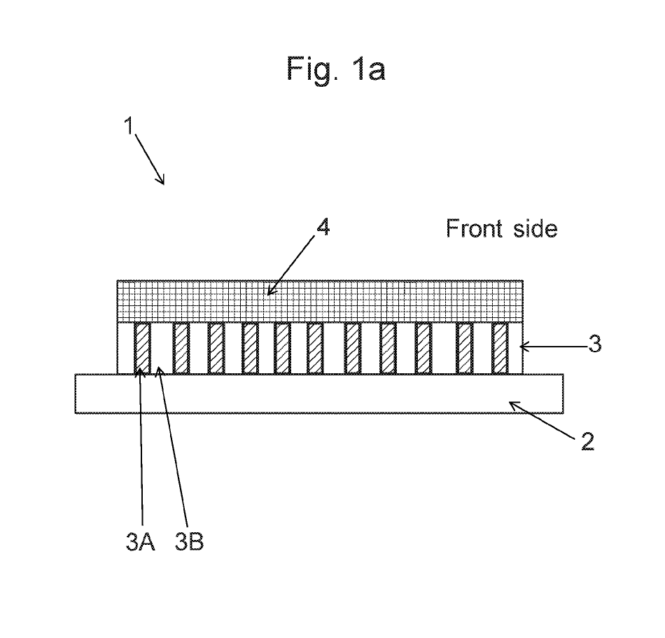

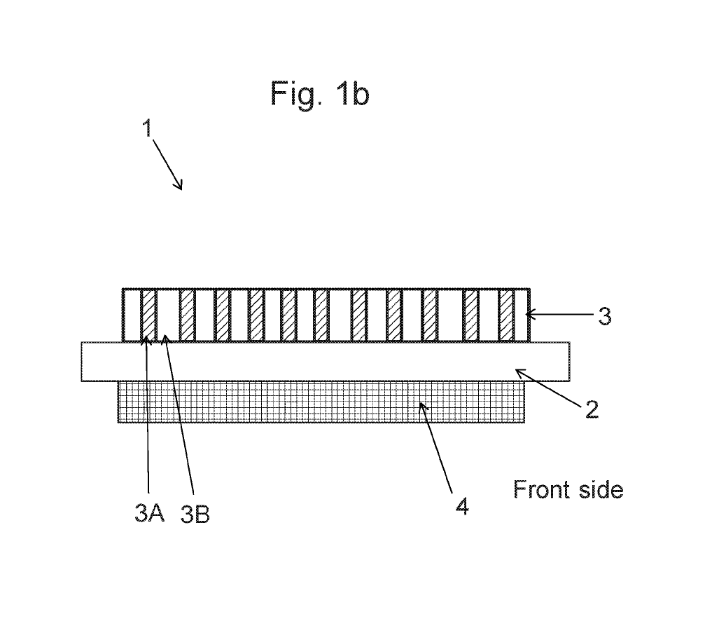

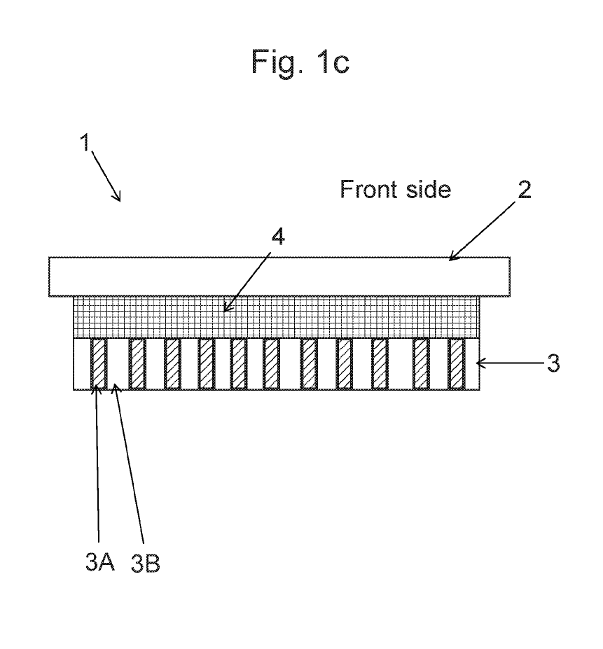

FIG. 1a shows a viewing region 1 of a security device having a transparent substrate 2. One side of the substrate 2 comprises a layer of optical interference structure material 4, in this case a Bragg stack. Examples of tunable Bragg stack structures suitable for use with the current invention can be found in WO2009/143625.

Examples of alternative optical interference structure materials suitable for use with the present invention include thin film interference structures and photonic crystal structures. Thin film interference structures comprise repeating layers of different refractive indices, examples can include purely dielectric stacks (metal oxide or polymer) or those composed of alternate dielectric and metallic layers.

Photonic crystal materials exhibit a periodic change in refractive index and, according to the spatial variation in the refractive index, are classified as one-dimensional (1D), two-dimensional (2D) and three-dimensional (3D). 1D photonic crystal structures correspond to thin film interference structures. 2D and 3D photonic crystal structures are structured optical materials in which the refractive index varies periodically in two or preferably three dimensions. These materials exhibit a range of interesting optical effects when subject to electromagnetic radiation of a wavelength comparable to the spatial modulation of the refractive index. Bragg reflection may occur over a range of wavelengths that depend on the direction of incidence/propagation and the periodicity of refractive index variation. This gives rise to photonic “energy gaps” that are analogous to the electronic band gaps in semiconductors. Typically, electromagnetic waves within a certain frequency range cannot propagate in particular directions within the crystal, and incident electromagnetic radiation at these wavelengths is consequently reflected. It is the presence of such partial photonic band gaps that gives rise to the angular dependent colour replay.

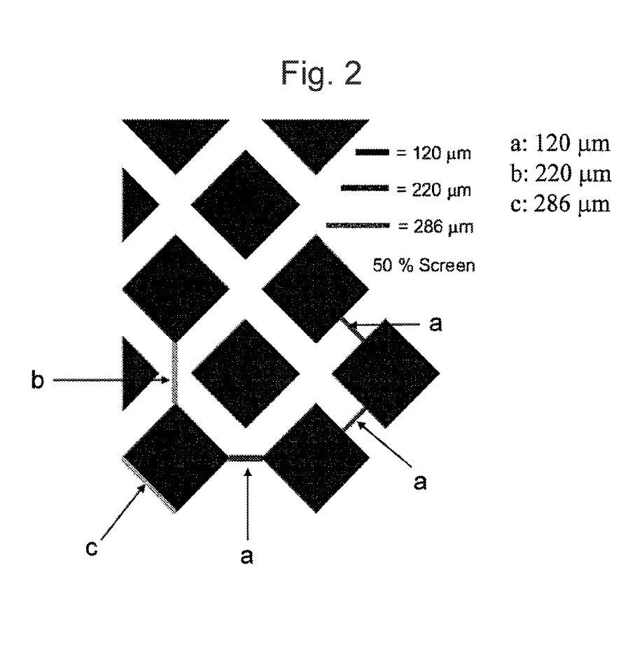

Referring back to FIG. 1a, the layer of optical interference structure material 4 is “backed” by a layer of at least partially light absorbing material, in this case a patterned screen 3 formed by an array of closely spaced fine lines 3A separated by spaces 3B (i.e. the screen pitch). In alternative, preferred embodiments, the screen is a fine dot screen, an example of which will be described with reference to FIG. 2. As shown in FIGS. 1a-1c, the location of the material 4 and screen 3 relative to the substrate may vary, since the substrate is transparent and primarily serves to carry the device, without interfering with the incident light or the optical effects. In preferred embodiments, the screen is located between the substrate and the layer of optical interference structure material as shown in FIG. 1a.

When illuminated by incident light, the material 4 exhibits a strong reflection effect and the spectral reflectance of the material varies with the angle at which it is viewed, so that the part of the spectrum which is strongly reflected changes as the device is tilted in relation to the direction of the illuminating light. In transmitted white light, a complementary colour to the main reflected colour is observed with a similar colour change on tilting. The width of the lines 3A and the spacing 3B between the lines of the patterned opaque coating is preferably non-resolvable such that the substrate appears a uniform colour which is the colour of the particular wavelength reflected by the optical interference structure material 4 at any specific angle of view in reflective light but appears uniformly transparent in transmissive light to enable the complementary transmission colours to be observed. The presence of the obscuring layer 3A enables the reflected layer to dominate by absorbing sufficient light which is transmitted through the optical interference structure material 4 and which would otherwise overwhelm and conceal the optically variable effect.

The light absorbing material may comprise for example a black or other dark-coloured material such as an ink and renders the overlying optical interference structure material visible in the second partial areas of the region by absorbing stray light other than that reflected by the material which would otherwise overwhelm and conceal the optically variable effect. It will be appreciated, however, that the light absorbing material need not absorb at all (UV and visible) wavelengths, and also need not absorb 100% of the light at those wavelengths it does absorb.

Advantageously, the light absorbing material absorbs at least 70% of incident visible light, preferably at least 80%, more preferably at least 90%. Visible light is defined here as meaning all light with wavelengths between 350 nm and 800 nm, inclusive.

Advantageously the light absorbing material is additionally non-transparent and preferably transmits less than 30% of incident visible light in a single pass, more preferably less than 20%, still preferably less than 10%, most preferably is substantially opaque.

Desirably, the light absorbing material is dark in colour, preferably black, although alternatives such as dark blue or dark green are also envisaged. For example, the light absorbing material may comprise an ink containing a dark pigment such as carbon black. The light absorbing material may also comprise a magnetic or electrically conductive substance, which may or may not be the same pigment as that which gives the material its colour.

The light absorbing material preferably comprises a visually dark, e.g. grey or black, substance such as an ink. An example of a suitable light-absorbing material which can be used in this and all other embodiments disclosed herein would be an ink carrier, lacquer or binder containing a black or dark dye or pigment such as the dye BASF Neozapon X51 or the pigment “carbon black 7” (well dispersed). The dye loading can be up to 50% (by weight) of the final coat of material depending on coat thickness and desired darkness.

Preferably, the absorbing layer is in the form of a screen. For example, the absorbing layer pattern could be an array of dots or lines with sufficient coverage such that sufficient stray light other than that reflected by the optically interference structure material which would otherwise overwhelm and conceal the optically variable effect is absorbed while being sufficient sufficiently transparent to enable the complementary colour to be viewable in transmitted light. Non-linear screens are also envisaged. For example the screen could comprise a circular or sinusoidal array of dots or lines. The screen can be regular or stochastic.

Preferably, the coverage of the screen pattern is in the range 20-80%, and more preferably in the range 40-70% and even more preferably in the range 50-70%. The width of the lines or the diameter of the dots forming the screen are preferably in the range 100-300 μm and the spaces between the dots or lines are also in the range 100-300 μm with values of each set chosen to achieve the desired screen coverage. The absorbing pattern could be an array of dots or lines with sufficient coverage to maintain the reflectivity of the optically variable material and therefore enable strong reflected colours, but sufficiently transparent to enable transmitted colours. This is particularly appropriate with a polymeric substrate. Preferably, the screen is a regular array forming a uniform dot screen. FIG. 2 shows a partial view of a uniform dot screen for use with the present invention. The geometry of the dots shown in FIG. 2 corresponds to 50% coverage of the screen. In this example, the dots are filled squares with a side of 286 μm, and a pitch of 120 μm representing the distance between adjacent squares.

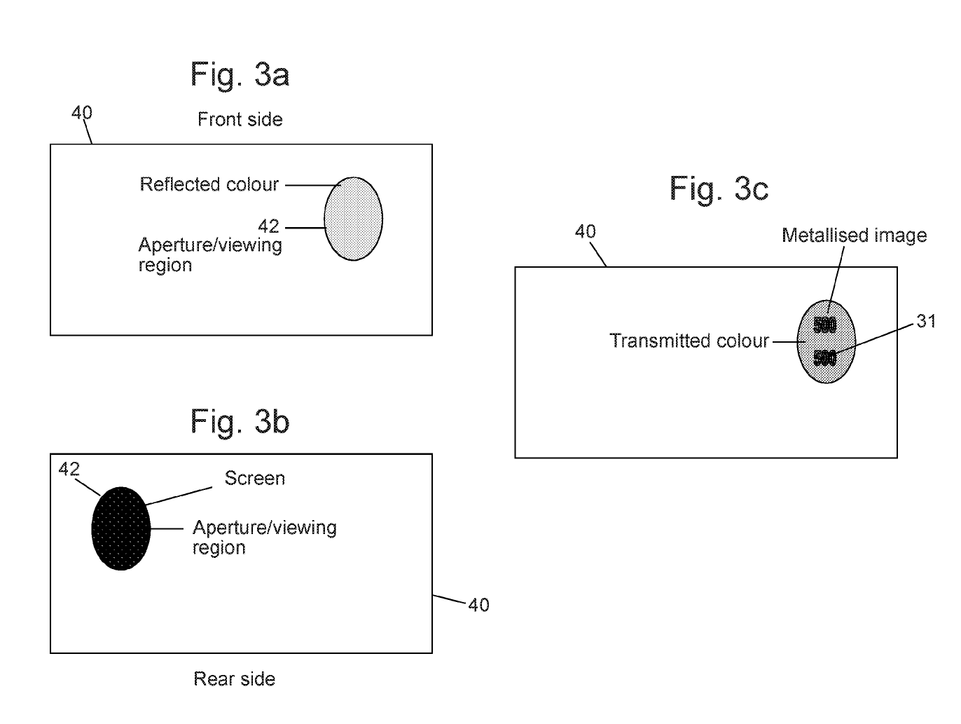

The appropriate patterning of the obscuring layer may further provide a means of integrating “hidden” images or transmission designs. FIG. 3 illustrates an example where the optically variable device of the current invention is incorporated into a transparent region of a paper substrate 40. In this example, most of the absorbing screen comprises an array of closely spaced fine lines or dots as described with reference to FIG. 1 or 2, but in the localised regions the absorbing coverage will be complete, i.e. substantially 100%, forming a permanent image 31 which is revealed in transmitted light, as shown in FIG. 3c. In an alternative embodiment, the absorbing screen will comprise a permanent image formed by an appropriate patterning of the screen.

On viewing the device from the front side, illustrated in FIG. 3, in reflection (FIG. 3a) the authenticator will observe strong reflection colours. On the front side the numeral “500” is visible on the exposed polymeric film apart from in the aperture region where it is effectively concealed by the optical interference structure material (typically it will only be present where the optically variable film is so will not be visible). On the rear side, numeral “500” is concealed by the complexity of the screen pattern but would be viewable on close examination in reflection. When viewing the device in transmission (FIG. 3c) the reflection colours disappear and are replaced by the brighter transmission colours and the numeral “500” becomes visible as a silhouette image against the substantially uniform coloured background. In this manner the optical interference structure material is used to conceal a permanent image 31 in reflected light which is then revealed when image disappears on viewing in transmitted light.

In another embodiment of the invention the absorbing screen could be created by using a light absorbing resist to pattern a metallised substrate using a resist and etch technique to create metallic screen elements superimposed with absorbing screen elements. In effect this would be the method described in EP1467873. The advantage of this is that from the front side the screen would be dark and absorbing, but from the back side the screen would be metallic and more attractive to the eye.

Embodiments of the invention are applicable to both paper and polymer substrates and the permanent image can be applied by printing as well as metallization or demetallisation techniques. Suitable printing techniques include lithography, UV cured lithography, intaglio, letterpress, flexographic printing, gravure printing or screen-printing. The permanent image must be sufficiently opaque to appear as a silhouette in transmitted light. The permanent image can take any form such as patterns, symbols and alphanumeric characters and combinations thereof. The indicia can be defined by patterns comprising solid or discontinuous regions which may include for example line patterns, fine filigree line patterns, dot structures and geometric patterns. Possible characters include those from non-Roman scripts of which examples include but are not limited to, Chinese, Japanese, Sanskrit and Arabic. The permanent image may be single-coloured or multi-coloured.

Security devices of the sorts described above can be utilised in many different ways. Preferably, in some cases the security device forms part of a security article, such as a security thread, patch, foil or strip, for application to or incorporation into a security document. In other examples, the security device may be formed directly on (i.e. integrally with) the security document.

The security device or article can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security device or article may be subsequently incorporated into a paper or polymer base substrate so that it is viewable from both sides of the finished security substrate. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and EP-A-1398174.

The security device may also be applied to one side of a paper substrate so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

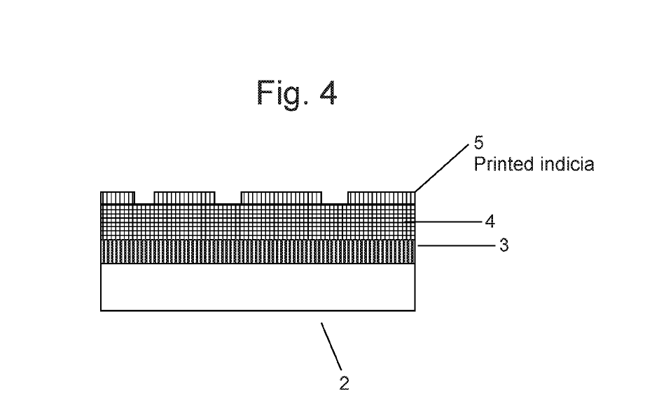

FIG. 4 shows a cross-sectional view of a further embodiment of the security device of the current invention. In this example, the device is intended for use as a security label and comprises an inverse opal photonic crystal film 4. On the front side of the photonic crystal film there are printed identifying indicia 5 using inks or dyes. The integration of the optically variable effects such as angular dependent reflected colours with a permanent image including indicia not only increases the aesthetics of the device but also makes it more memorable to the general public. In the example illustrated, the optically variable effects are used to draw the attention of the viewer to the permanent image that can contain important information such as the value of the protected document.

1-28. (canceled)

29. An optically variable device comprising a substrate having a transparent viewing region and a layer of optical interference structure material for selectively reflecting and transmitting incident light to generate an optically variable effect, the layer of optical interference structure material having a front side and a rear side, the device further comprising an absorbing layer comprising an at least partially light absorbing material on the rear side of the layer of optical interference structure material, such that,
when a region on the front side of the layer of optical interference structure material receives incident light and the device is viewed in reflected light, the absorbing layer is sufficiently opaque to absorb light that passes through the optical interference structure material and the optically variable effect is observable in reflected light; and
when the same region on the front side is viewed in transmitted light, the absorbing layer is sufficiently transparent to permit the passage of light with an intensity that exceeds the intensity of reflected light for the optically variable effect to be observable in transmitted light,
wherein the absorbing layer is in the form of a screen.

30. A device according to claim 29, wherein the optical variable effect in the reflected light is complementary to the optical variable effect in the transmitted light at all viewing angles.

31. A device according to claim 29, wherein, when the incident light is white light, the optically variable effect is a colour effect.

32. A device according to claim 29, wherein the optically variable effect is an angularly dependent colour effect.

33. A device according to claim 29, wherein the layer of optical interference structure material is located on one side of the substrate and the absorbing layer is located on the same side of the substrate.

34. A device according to claim 33, wherein the absorbing layer is located between the substrate and the layer of optical interference structure material.

35. A device according to claim 29, wherein the layer of iridescent amplitude interference material is located on one side of the substrate and the absorbing layer is located on the other side of the substrate.

36. A device according to claim 29, wherein the at least partially light absorbing material absorbs at least 70% of incident visible light, preferably at least 80%, more preferably at least 90%.

37. A device according to claim 29, wherein the at least partially light absorbing material is additionally non-transparent and preferably transmits less than 30% of incident visible light in a single pass, more preferably less than 20%, still preferably less than 10%, most preferably substantially opaque.

38. A device according to claim 29, wherein the screen is regular or stochastic.

39. A device according to claim 29, wherein the coverage of the screen pattern is in the range 20-80%, and more preferably in the range 40-70% and even more preferably in the range 50-60%.

40. A device according to claim 29, wherein the width of the lines or the diameter of the dots forming the screen are preferably in the range 100-300 μm and spaces between the dots or lines are also in the range 100-300 μm.

41. A device according to claim 29, wherein parts of the screen are filled to define an image such as indicia.

42. A device according to claim 29, wherein the layer of iridescent amplitude interference material comprises a photonic crystal.

43. A device according to claim 29, wherein the layer of optical interference structure material comprises any of a thin film interference structure, interference pigments, iridescent pigments, pearlescent pigment, mica pigment, and liquid crystal pigments.

44. A device according to claim 29, wherein the substrate comprises a transparent polymer provided with an opacifying coating, the viewing region being defined by omitting the opacifying coating in a localised region.

45. A device according to claim 29 wherein the shapes of each of the absorbing layer and the optical interference structure material are the same such that they have similar footprints that are coincident.

46. A security document provided with a security device according to claim 29.

47. A security document according to claim 46, the security document being chosen from the group comprising banknotes, fiscal stamps, cheques, postal stamps, certificates of authenticity, articles used for brand protection, bonds, payment vouchers, and the like.

48. A method of forming an optically variable device, comprising the steps of:
providing a substrate having a transparent viewing region;
providing, in the transparent viewing region, a layer of optical interference structure material for selectively reflecting and transmitting incident light to generate an optically variable effect, the layer of optical interference structure material having a front side and a rear side, and
providing an absorbing layer comprising an at least partially light absorbing material on the rear side of the layer of optical interference structure material, such that:
when a region on the front side of the layer of optical interference structure material receives incident light and the device is viewed in reflected light, the absorbing layer is sufficiently opaque to absorb light that passes through the optical interference structure material and the optically variable effect is observable in reflected light; and
when the same region on the front side is viewed in transmitted light, the absorbing layer is sufficiently transparent to permit the passage of light with an intensity that exceeds the intensity of reflected light for the optically variable effect to be observable in transmitted light,
wherein the absorbing layer is in the form of a screen.
